(19) United States
(12) Patent Application Publication
(10) Pub. No.: US 2015/0060484 A1
(43) Pub. Date: Mar. 5, 2015

(54) DISCHARGE PUMP MAKING SOUND WHEN PUMPING

(71) Applicant: Young-Kwang Byun, Seoul (KR)

(72) Inventor: Young-Kwang Byun, Seoul (KR)

(21) Appl. No.: 14/107,722

(22) Filed: Dec. 16, 2013

(30) Foreign Application Priority Data
Sep. 2, 2013 (KR) 1020130104978

(51) Int. Cl. B05B 11/00

(52) U.S. Cl. CPC B05B 11/3042
USPC 222/39; 222/321.9

(57) ABSTRACT

A discharge pump discharging contents such as cosmetics, shampoos, detergents, or perfumes accommodated in a container by pushing the discharge pump to the outside, more particularly to, a discharge pump making sounds when pumping contents out. The discharge pump making sounds when pumping, characterized in that when a push button is pushed, a content within a container is pumped and discharged to the outside, and when force pushing the push button is released, the push button returns to its original state by a coil spring. A sound making unit for making sounds, which contacts and overlaps all or a portion of a plurality of spiral parts constituting the coil spring when compressed, and returns to its original state while scratching the spiral parts contacting the sound making unit when tensioned, thereby making the sounds, is disposed on an end of the coil spring and bent from the spiral part.

### CROSS-REFERENCE TO RELATED APPLICATION(S)

Korean Patent Application KR 10-2013-0104978 with a filing date of Sep. 2, 2013, is incorporated herein by reference.

### BACKGROUND OF THE INVENTION

1. Field of the Invention

The present invention relates to a discharge pump discharging contents such as cosmetics, shampoos, detergents, or perfumes accommodated in a container by pushing the discharge pump to the outside, more particularly to, a discharge pump making sounds when pumping contents out.

2. Description of the Related Art

Typically, containers for cosmetics, shampoos, detergents, and perfumes are provided with discharge pumps to discharge contents therein by pumping to the outside. The discharge pumps are widely used because the discharge pumps have an advantage of discharging easily a predetermined amount of contents while storing the contents in the container.

Since the typical discharge pumps do not make any sounds when pumping and discharging the contents out, it may difficult to identify whether the pumping is smoothly being performed if the discharge pumps are pumped without checking the pumping with the naked eyes. Also, it may difficult to identify the pumped degree even if the pumping is checked with the naked eyes.

To solve such limitations, a discharge pump making sounds when pumping is developed and disclosed in Korean Utility Model Gazette No. 20-0294063 (hereinafter, referred to as a ‘related document’).

According to the related document, the discharge pump makes sounds whenever a nozzle button is pressed to pump contents, thereby to easily notify an operation state of the pumping and to easily adjust the number of pumping. To realize this, the discharge pump includes a valve stopper disposed on a lower end of a valve rod connected to the nozzle button, and a plurality of projections protrude from an inner circumferential surface of a piston supporting member on which the valve rod slid. Thus, when the valve stopper of the valve rod passes through the projections, the valve stopper may contact the projections to make sounds.

In the case of the discharge pump according to the related document, the valve stopper has to be integrally injection-molded with the lower end of the valve rod, and also the plurality of projections have to be integrally injection-molded with the inner circumferential surface of the piston support member. Thus, the discharge pump according to the related document has a complex structure and needs a lot of manufacturing costs. Also, when the valve stopper and the projection are worn due to use for long periods of time, the discharge pump does not smoothly make sounds. Furthermore, since all of the valve stopper and the piston support member have to be replaced when replaced, their replacement costs may increase.

### SUMMARY OF THE INVENTION

Accordingly, the present invention is directed to a discharge pump that substantially obviates one or more problems due to limitations and disadvantages of the related art. The discharge pump makes sounds through a simple sound making structure when pumping to realize a simple structure thereof and reduce manufacturing and replacement costs.

Embodiments of the present invention provide a discharge pump making sounds when pumping, the discharge pump is characterized in that when a push button is pushed, a content within a container is pumped and discharged to the outside, and when force pushing the push button is released, the push button returns to its original state by a coil spring, wherein a sound making unit for making sounds, which contacts and overlaps all or a portion of a plurality of spiral parts constituting the coil spring when compressed, and returns to its original state while scratching the spiral parts contacting the sound making unit when tensioned, thereby making the sounds, is disposed on an end of the coil spring and bent from the spiral part.

In some embodiments, the sound making unit may include a first bending part bent from the lowermost spiral part to overlap the spiral parts when compressed; and a second bending part bent from an end of the first bending part to scratch the spiral parts when tensioned, thereby making the sounds.

In other embodiments, the first bending part may be inclinedly bent toward a central portion of the spiral parts so that the first bending part contacts the spiral parts when the spiral parts are compressed and tensioned, the second bending part may be inclinedly bent in the inclined direction of the spiral part.

### BRIEF DESCRIPTION OF THE DRAWINGS

FIG. 1 is a perspective view of a cosmetic container to which a discharge pump is applied according to a first embodiment of the present invention.

FIG. 2 is an exploded perspective view of the cosmetic container of FIG. 1.

FIG. 3 is a cross-sectional view of the cosmetic container of FIG. 1.

FIG. 4 is an exploded perspective view of the discharge pump of FIGS. 2 and 3.

FIG. 5 is a cross-sectional view of the discharge pump.

FIG. 6 is a perspective view of a pump body.

FIG. 7 is a cross-sectional view of the pump body.

FIG. 8 is a perspective view of a push button.

FIG. 9 is a cross-sectional view of the push button.

FIG. 10 is a perspective view of a valve.

FIG. 11 is a plan view of the valve.

FIG. 12 is a cross-sectional view of the valve.

FIG. 13 is a perspective view of an end cap.

FIG. 14 is a cross-sectional view of the end cap.

FIG. 15 is a perspective view of a valve holder.

FIG. 16 is a cross-sectional view of the valve holder.

FIG. 17 is a perspective view of a spring.

FIG. 18 is a side view of the spring.

FIGS. 19 and 20 are views illustrating a structure for making sounds when the spring is operated.

FIG. 21 is a perspective view of a connection tool.

FIG. 22 is a cross-sectional view of the connection tool.

FIG. 23 is a cross-sectional view illustrating a state where content in a container body flow into the discharge pump.

FIG. 24 is a cross-sectional view illustrating a state where the content introduced into the discharge pump is discharged to the outside.

FIG. 25 is a cross-sectional view of a cosmetic container to which a discharge pump is applied according to a second embodiment of the present invention.

FIG. 26 is a cross-sectional view of the discharge pump of FIG. 25.

FIG. 27 is a cross-sectional view of a pump body.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a discharge pump making sounds when pumping according to preferred embodiments of the present invention will be described in detail with reference to the accompanying drawings.

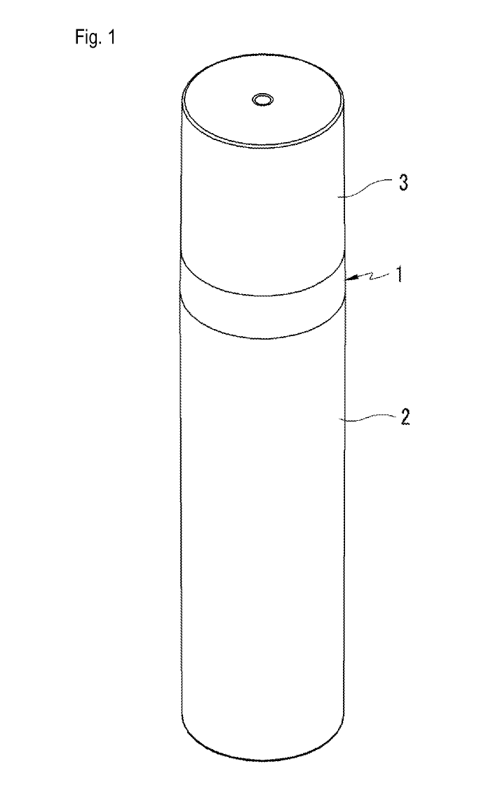

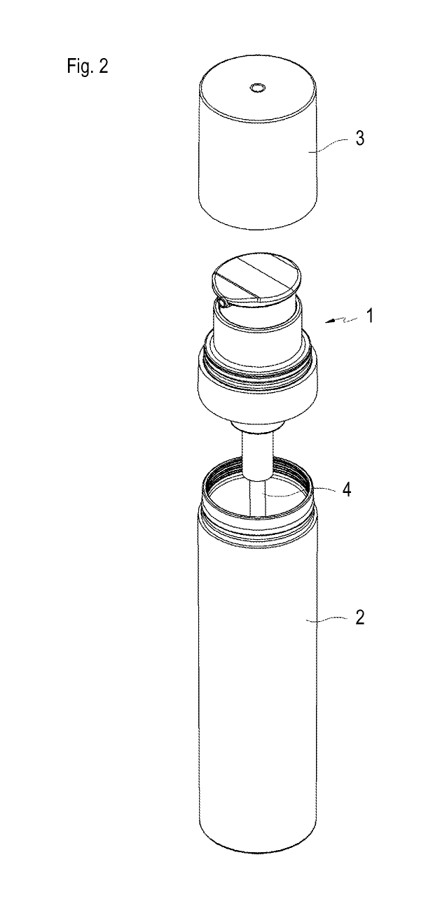

FIG. 1 is a perspective view of a cosmetic container to which a discharge pump is applied according to a first embodiment of the present invention, and FIG. 2 is an exploded perspective view of the cosmetic container of FIG. 1.

A cosmetic container to which a discharge pump is applied according to the present invention includes a discharge pump 1, a container body 2, a lid 3, and a pumping tube 4.

The discharge pump 1 is coupled to an opened upper end, i.e., an inlet of the container body 2 to allow a user to discharge liquid content in a pumping manner.

The container body 2 has an upwardly opened circular tube shape. The container body 2 is filled with liquid content such as a cosmetic, a shampoo, a detergent, a perfume, or the like.

The lid 3 is detachably fixed to the outside of the discharge pump 1 to cover and protect the discharge pump 1 when the discharge pump 1 is not used.

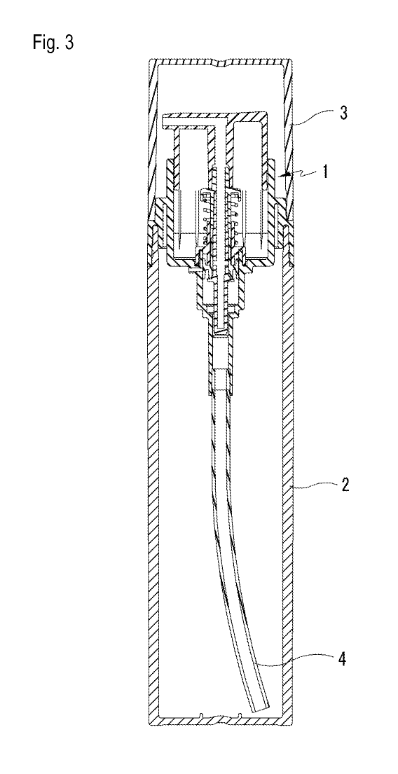

FIG. 3 is a cross-sectional view of the cosmetic container of FIG. 1.

The container body 2 includes the pumping tube 4 having a discharge passage therein to smoothly discharge the content. The pumping tube 4 has an upper end connected to the discharge pump 1 and a lower end spaced a predetermined distance from a bottom of the container body 2.

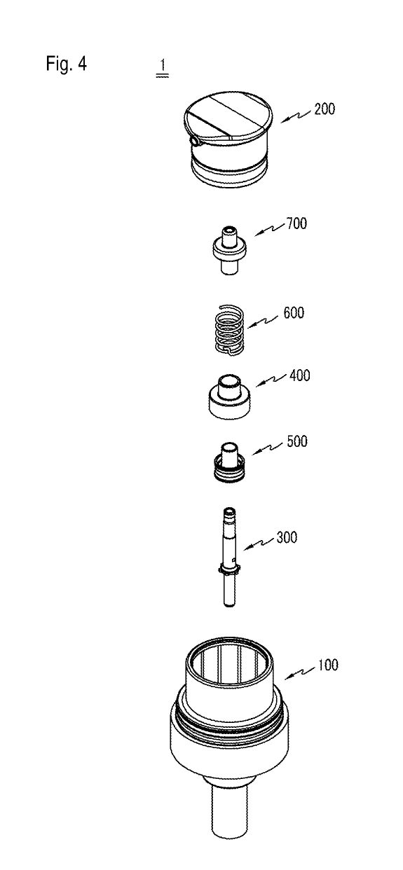

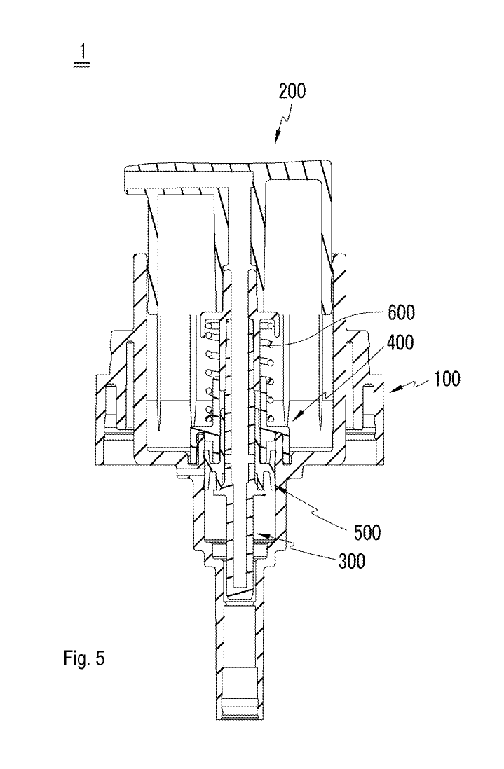

FIG. 4 is an exploded perspective view of the discharge pump of FIGS. 2 and 3. FIG. 5 is a cross-sectional view of the discharge pump.

The discharge pump 1 according to the present invention includes a pump body 100, a push button 200, a valve 300, an end cap 400, a valve holder 500, a spring 600, and a connection tool 700.

The pump body 100 is coupled to an inlet of the container body 2 to introduce the content through a lower end thereof. The valve 300, the end cap 400, the valve holder 500, the spring 600, and the connection tool 700 are disposed within the pump body 100.

The push button 200 is elevatably disposed on an upper end of the pump body 100 to discharge the content to the outside by repeatedly pressing and releasing the push button 200 by the user.

The valve 300 is interlocked with the push button 200 to open or close the lower end of the pump body 100 while being elevated, thereby controlling the introduction of the content into the pump body 100. Here, the valve 300 may serve as a passage for transferring the introduced content to the push button 200.

The end cap 400 may shield a space in which the content introduced in the pump body 100 is filled to prevent the content from leaking to the outside of the space and support a lower end of the spring 600.

The valve holder 500 together with the end cap 400 may shield the space where the content introduced in the pump body 100 is filled. The valve holder 500 may allow the content to flow into the valve 300 when the valve descends. Also, the valve holder 500 may block the introduction of the content into the valve 300 when the valve ascends.

The spring 600 may elastically support the push button 200 so that the push button 200 returns to its original state when force pressing the push button 200 is released.

The connection tool 700 may connect the push button 200 to the valve 300 and support an upper end of the spring 600.

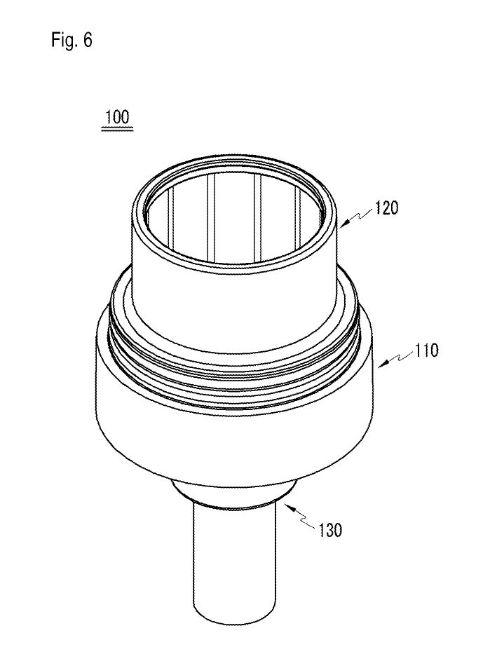

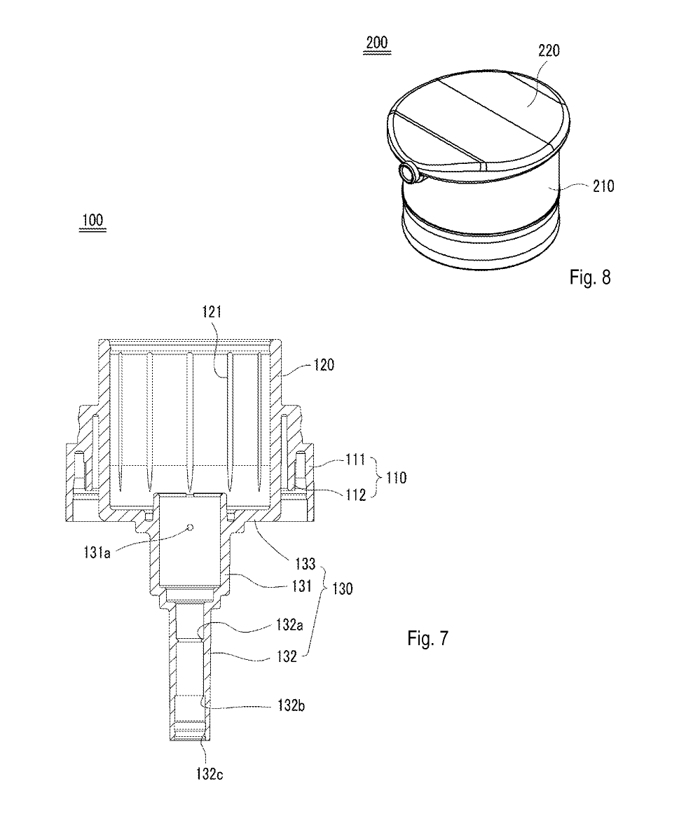

FIG. 5 is a cross-sectional view of the discharge pump, FIG. 6 is a perspective view of the pump body, and FIG. 7 is a cross-sectional view of the pump body.

The pump body 100 includes a container coupling unit 110, a valve mounting unit 120, and a content inflow unit 130, which are integrally injection-molded.

The container coupling unit 110 is coupled to the inlet of the container body 2. The container coupling unit 110 includes a cylindrical outer coupling tube 111 fitted to the outside of the inlet of the container body 2 and a cylindrical inner coupling tube 112 which is integrally provided within the outer coupling tube 111 with a predetermined distance and fitted to the inside of the inlet of the container body 2. The outer coupling tube 111 has an upper end integrally connected to a central portion of the inner coupling tube 112. The outer coupling tube 111 is firmly fixed to the outside of the inlet of the container body 2 by a projection and groove. Thus, the pump body 100 is firmly coupled to the inlet of the container body 2.

The valve 300, the end cap 400, the valve holder 500, the spring 600, and the connection tool 700 are mounted within the valve mounting unit 120. The valve mounting unit 120 has a cylinder shape and a central portion integrally connected to an upper end of the inner coupling tube 112 within the inner coupling tube 112. The push button 200 is elevatably inserted inside the valve mounting unit 120 and, a plurality of concave grooves 121 are lengthily defined in a longitudinal direction at a predetermined distance in an inner circumferential surface of the valve mounting unit 120.

When the valve 300 is elevated, the content within the container body 2 is introduced into the content inflow unit 130. The content inflow unit 130 includes a cylindrical content inflow tube 131 extending from a lower end of the valve mounting unit 120 and a tube fixing tube 132 extending downward from a lower end of the content inflow tube 131. The content inflow tube 131 to which the contents are introduced therein when the valve 300 is operated. Here, the valve 300 may be elevated within the content inflow tube 131 to introduce the content into the content inflow tube 131, and the tube fixing tube 132 may have a diameter less than that of the content inflow tube 131 so that an upper end of the pumping tube 4 is fixedly inserted into the tube fixing tube 132. A connection unit 133 is disposed between the outside of the upper end of the content inflow tube 131 and the lower end of the valve mounting unit 120 to integrally connect thereto.

An air ventilation hole 131a is defined in a side surface of the content inflow tube 131 so that air is ventilated between the outside and inside of the content inflow tube 131. The air ventilating hole 131a has an outlet disposed under the connection unit 133.

A shield projection 132a protrudes from an upper portion of the inside of the tube fixing tube 132 so that the tube fixing tube 132 is blocked by a lower end of the valve stem 310 to prevent the content from ascending when the valve 300 descends and is opened to allow the content to ascend when the valve 300 ascends. Here, a first inflow hole is defined by the shield projection 132a. An insert limitation jaw 132b for tightening the inserted pumping tube 4 to fix the pumping tube 4 to the tube fixing tube 132 protrudes under the insert limitation jaw 132b.

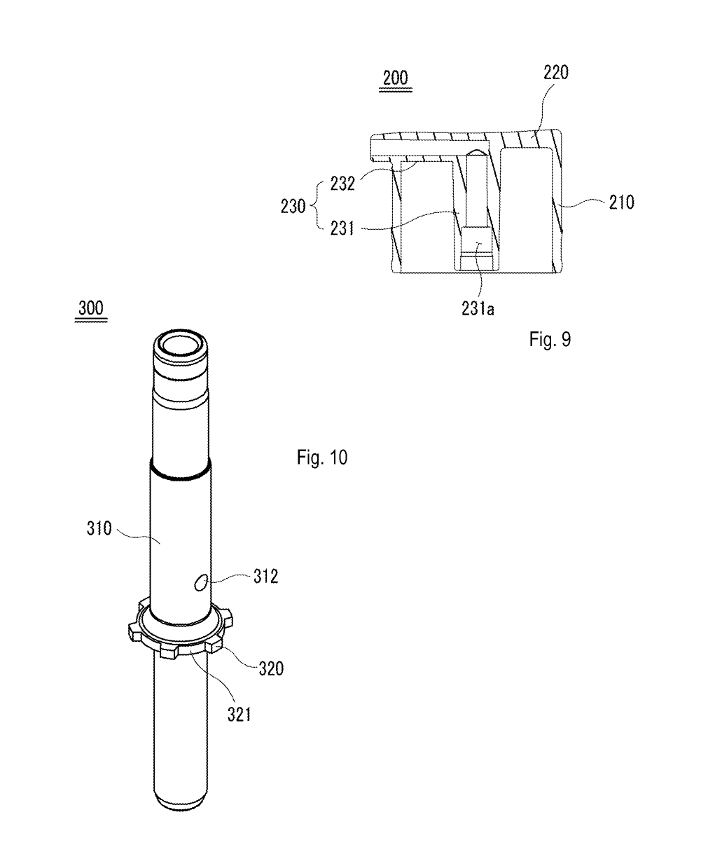

FIG. 5 is a cross-sectional view of the discharge pump, FIG. 8 is a perspective view of the push button, and FIG. 9 is a cross-sectional view of the push button.

The push button 200 includes an elevation unit 210, a push surface 220, and a content discharge unit 230, which are integrally injection-molded.

The elevation unit 210 may have a cylindrical shape and be elevatably inserted into the valve mounting unit 120.

The push surface 220 has a surface shape which shields an opened upper end of the elevation unit 210 and is pushed by a user's hand.

The content discharge unit 230 serves as a passage through which the content transferred through the valve 300 is discharged to the outside. The content discharge unit 230 includes a cylindrical vertical tube 231, which is vertically disposed on a bottom surface of the push surface 220 and has a content transfer path therein, and a discharge tube 232, which is horizontally integrated with a lower portion of the push surface 220 and has a content discharge path therein. A valve fixing groove 231a to which the upper end of the valve 300 is inserted and fixed is defined in a lower end of the inside of the vertical tube 231. The upper end of the valve 300 may be firmly fixed to the valve fixing groove 231a by the projection and groove.

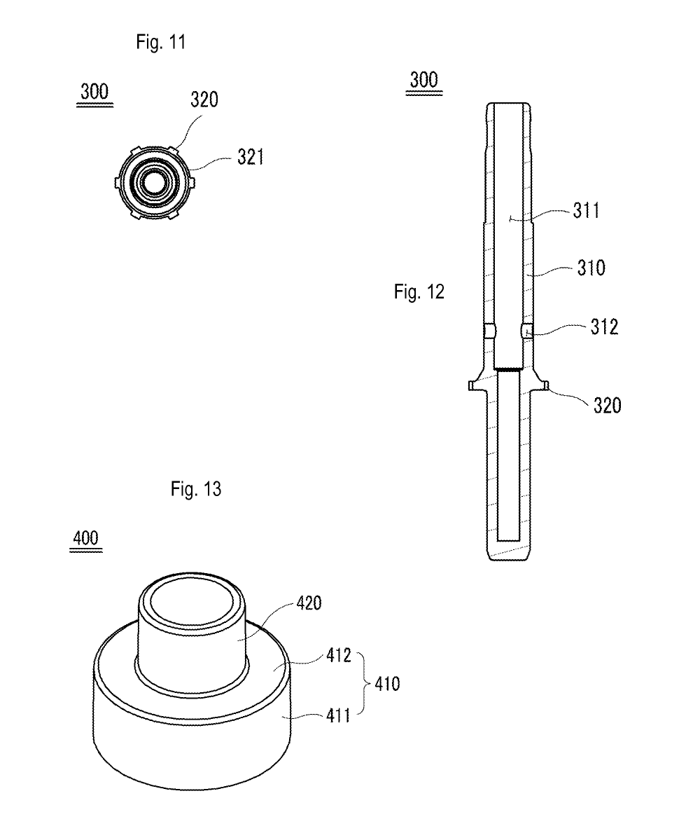

FIG. 5 is a cross-sectional view of the discharge pump, FIG. 10 is a perspective view of the valve, FIG. 11 is a plan view of the valve, and FIG. 12 is a cross-sectional view of the valve.

The valve 300 includes the valve stem 310 and a circular protrusion 320.

The valve stem 310 has a vertical transfer path 311, which is lengthily disposed therein and has an opened upper end and a closed lower end, and a second inflow hole 312, which is horizontally disposed in a side portion thereof to introduce the content into the vertical transfer path 311. The closed lower end of the valve stem 310 may pass through the first inflow hole to open or close the first inflow hole. The upper end of the valve stem 310 may be firmly fixed to the valve fixing groove 231a of the push button 200 by the projection and groove.

The circular protrusion 320 is disposed spaced apart from the second inflow hole 312 defined in the side portion of the valve stem 310 toward the closed other end of the valve stem 310. Thus, when the valve stem ascends, the circular protrusion 320 hooks the valve stem 310 to the valve holder 500 to prevent the valve stem 310 from ascending no longer. A plurality of fine holes 321 through which the liquid content filled into the content inflow tube 131 pass are radially disposed spaced apart from each other in the circular protrusion 320.

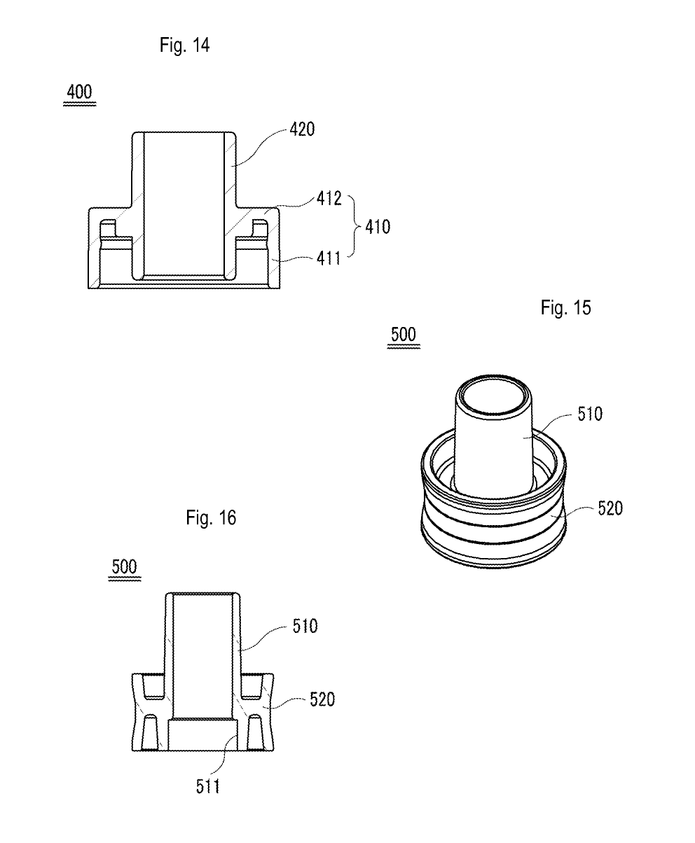

FIG. 5 is a cross-sectional view of the discharge pump, FIG. 13 is a perspective view of the end cap, and FIG. 14 is a cross-sectional view of the end cap.

The end cap 400 includes a spring seat unit 410 and a spring support unit 420, which are integrally injection-molded.

The spring seat unit 410 is fixed to the upper end of the content inflow tube 131 to seat and support the lower end of the spring 600 on a top surface thereof while shielding the opened upper end of the content inflow tube 131. The spring seat unit 410 includes a cylindrical fixing tube 411 fixed to the outside of the content inflow tube 131 and a ring-shaped seat surface 412 horizontally extending from an upper end of the fixing tube 411 to seat and support the lower end on a top surface thereof. The upper end of the content inflow tube 131 may be firmly fixed to an inner circumferential surface of the fixing tube 411 by the projection and groove.

The spring support unit 420 is provided as a cylindrical tube vertically integrated with a central portion of the seat surface 412. The valve stem 310 slidably passes through inside the spring support unit 420. The lower end of the spring 600 is fitted outside the spring support unit 420 to stably maintain the lower end of the spring 600 in position.

FIG. 5 is a cross-sectional view of the discharge pump, FIG. 15 is a perspective view of the valve holder, and FIG. 16 is a cross-sectional view of the valve holder.

The valve holder 500 is fitted between the valve stem 310 and the spring support unit 420 in the content inflow tube 131 to prevent the content from leaking between the valve stem 310 and the spring support unit 420. Also, the valve stem 310 passes through the valve holder 500, and thus the valve holder 500 may open the second inflow hole 312 when the valve stem 310 descends and may shield the second inflow hole 312 when the valve stem 310 ascends.

The valve holder 500 includes a cylindrical valve adhesion unit 510 closely attached to an outer surface of the valve stem 310 and a cylindrical inflow tube adhesion unit 520 closely attached to an inner surface of the content inflow tube 131.

A gap groove 511 is disposed in a side of the circular protrusion 320 of the valve 300 in the inner circumference surface of the valve adhesion unit 510 to generate a gap without contacting the valve stem 310. Thus, when the valve stem 310 descends to allow the second inflow hole 312 to overlap the gap groove 511, the content introduced to the gap groove 511 may be introduced into the valve stem 310 through the second inflow hole 312. On the other hand, when the valve stem 310 ascends to allow the second inflow hole 312 to be dislocated with respect to the gap groove 511, the content is not introduced into the valve stem 310 through the second inflow hole 312 by the inner circumferential surface of the valve adhesion unit 510 which is in contact with the valve stem 310.

An inflow tube adhesion unit 520 has a shape of which a central portion is further recessed inward than upper and lower portions thereof. Thus, the central portion of the inflow tube adhesion unit 520 does not contact the inner circumferential surface of the content inflow unit 130, and only the upper and lower portions of the inflow tube adhesion unit 520 contact the inner circumferential surface of the content inflow unit 130.

The valve adhesion unit 510 and the inflow tube adhesion unit 520 of the valve holder 500 are integrally injection-molded.

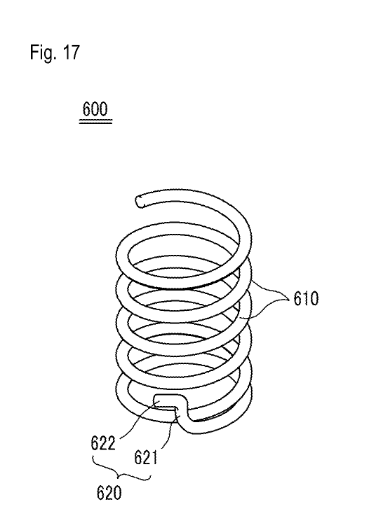

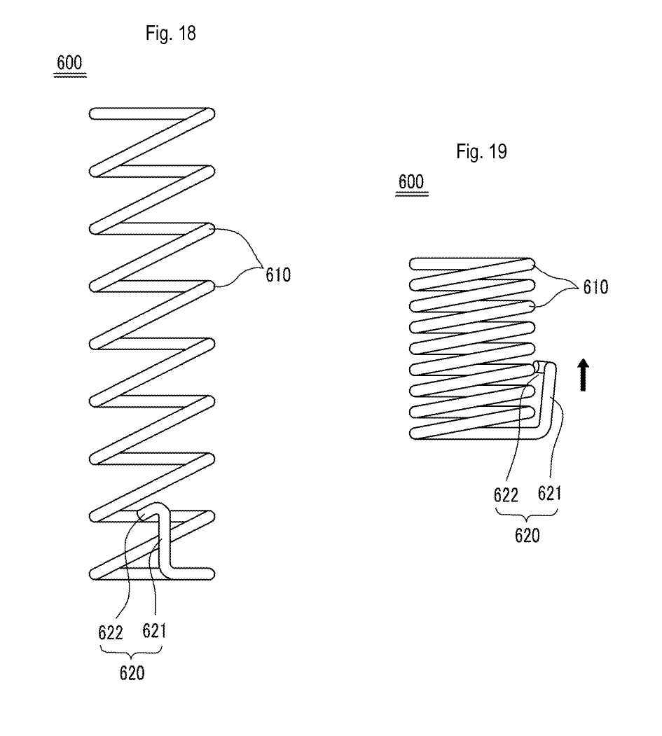

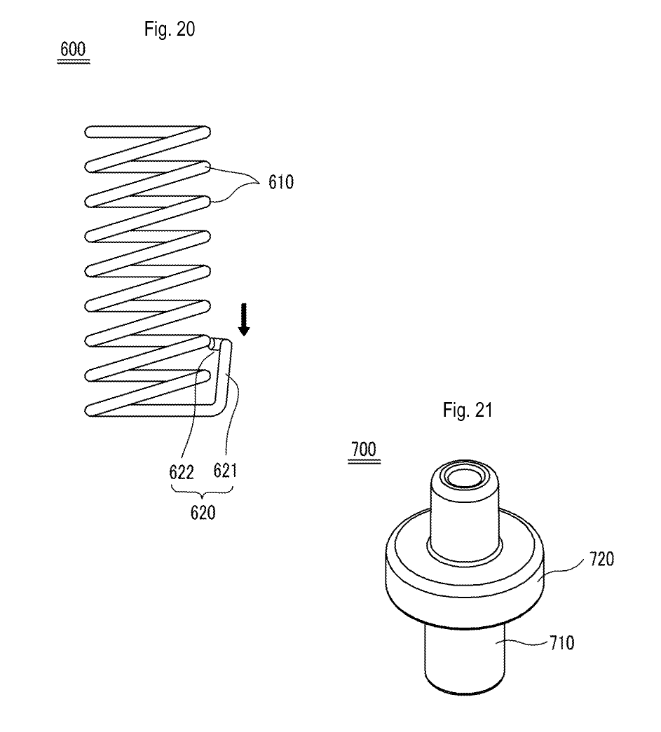

FIG. 5 is a cross-sectional view of the discharge pump, FIG. 17 is a perspective view of the spring, FIG. 18 is a side view of the spring, and FIGS. 19 and 20 are views illustrating a structure for making sounds when the spring is operated.

The spring 600 of which the lower end is supported by the end cap 400, and the upper end is supported by the connection tool 700 in the state where the spring is fitted outside the valve stem 310 may elastically support the push button 200 with respect to the end cap 400. Thus, when the user's hand is released from the push button 200 in the state where the user pushes the push button 200, the push button 200 may be ascend to return to its original state by restoring force of the spring 600.

The spring 600 may be a coil spring including a plurality of spiral parts 610 which are connected to each other. A sound making unit 620 may contact and overlap all or a portion of the plurality of spiral parts 610 when the spiral parts 610 are compressed and may return to its original position while scratching the spiral parts 610 contacting the sound making unit 620 when each of the spiral parts 610 is tensioned, thereby making sounds. As shown in the drawings, the sound making unit 620 may be disposed on only one end of the spring 600. Alternatively, the sound making units 620 may be disposed on both ends of the spring 600. If the sound making units 620 are disposed on both ends of the spring 600, the sound making units 620 may be disposed at different positions to prevent the sound making units 620 from collide with each other.

The sound making unit 620 includes a first bending part 621 bent from the spiral part 610 disposed on the end of the spring 600 to overlap the spiral parts 610 when spiral parts 610 are compressed and a second bending part 622 bent from an end of the first bending part 621 to make sounds while scratching the spiral part 610 when the spiral parts 610 are tensioned.

The first bending part 621 may be inclinedly bent toward a central portion of the spiral parts 610 so that the first bending part 621 contacts the spiral part 610 when the spiral parts 610 are compressed and tensioned. That is, since the first bending part 621 has elastic force in itself, when the end portion of the first being unit 621 is bent and closely attached to the spiral parts 610, the second bending part 622 may make sounds while strongly scratching the second bending part 621.

The second bending part 622 may be inclinedly bent in the inclined direction of each of the spiral part 610 to expand the portion contacting the spiral part 610. That is, if the contact area of the second bending part 622 is expanded in a state where the second bending part 622 is strongly attached to the spiral part 610, the sounds may intense by the expanded contact area.

According to the sound making unit 620 configured as described above, the sound making unit 620 may make sounds when the spring 600 is compressed as illustrated in FIG. 9. Alternatively, the making unit 620 may make intense sound when the spring 600 is tensioned as illustrated in FIG. 20. While the spring 600 is tensioned, the push button 200 pressing the spring 600 may return to its original state.

As shown in FIG. 19, when the spring 600 is compressed, all of the first and second bending parts 621 and 622 are in contact with the outer surface of the spiral part 610. In the process of compressing, the second bending part 622 may scratch the spiral part 610 to make sounds while the second bending part 622 contacts the outside portion of the spiral part 610 after the second bending part 622 contacts the lower portion of the spiral part 610.

As shown in FIG. 20, when the spring 600 is tensioned, the second bending part 622 may scratch the spiral part 610 to make sounds while the second bending part 622 contacts the outside portion of the spiral part 610 after the second bending part 622 contacts the upper portion of the spiral part 610. Here, since the first bending part 621 has a shape bent toward the inside of the spiral part 610, the second bending part 622 may effectively contact the upper portion of the spiral part 610 while being tensioned.

As described above, since a portion of the spring 600 is bent to form the sound making unit 620, the sound making unit 620 may make sounds through a simple structure when pumping to easily adjust the number of pumping and also reduce manufacturing and replacing costs due to the whole simple structure thereof.

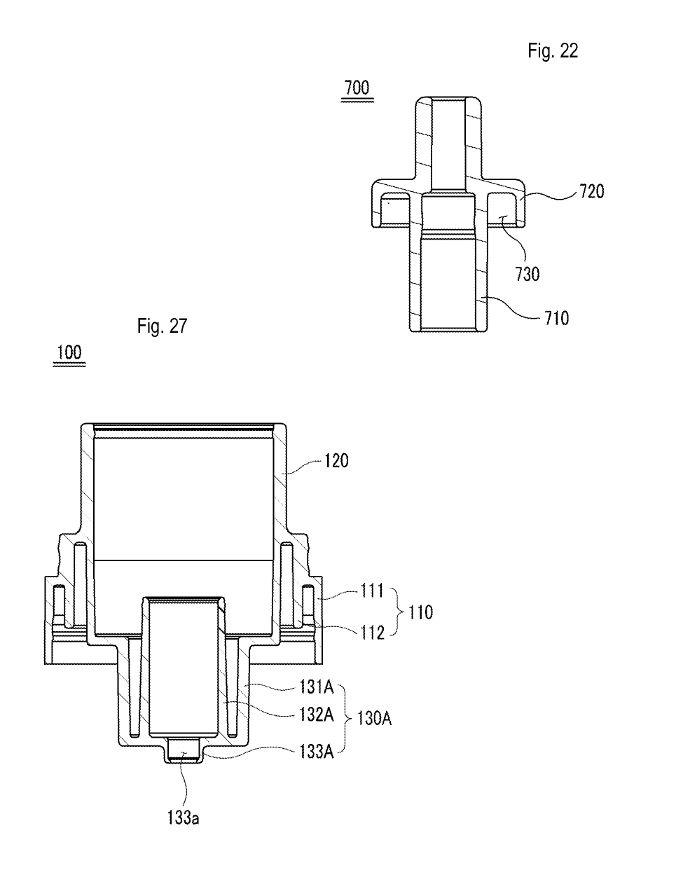

FIG. 5 is a cross-sectional view of the discharge pump, FIG. 21 is a perspective view of the connection tool, and FIG. 22 is a cross-sectional view of the connection tool.

The connection tool 700 includes a connection unit 710 and a spring support unit 720, which is integrally injection-molded.

The connection unit 710 may have a hollow tube shape to provide the content transfer path therein. The connection unit 710 has an upper end inserted and fixed to the vertical tube 231 of the push button 200 and a lower end to which the opened upper end of the valve stem 310 is inserted and fixed. The upper end of the spring 600 is fitted outside the lower end of the connection unit 710.

The spring support unit 720 may extend from the outside of the connection unit 710 to support the upper end of the spring 600. A spring fitting groove 730 is disposed between the spring support unit 720 and the connection unit 710.

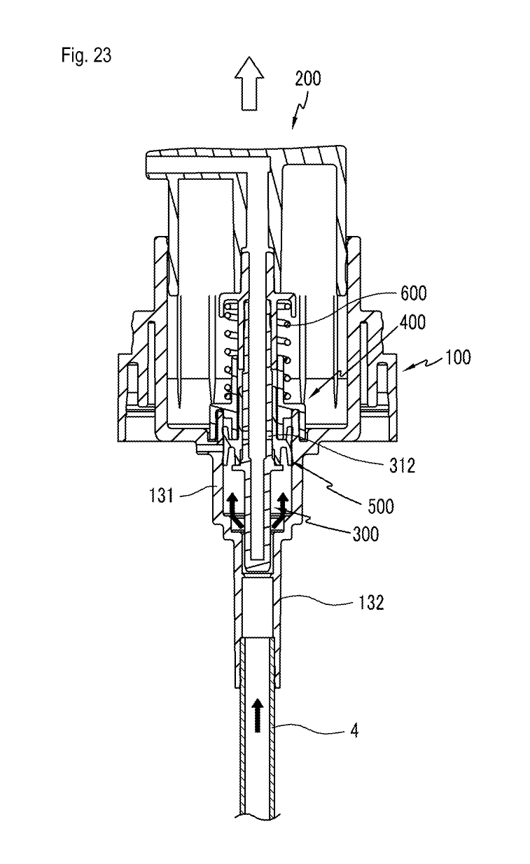

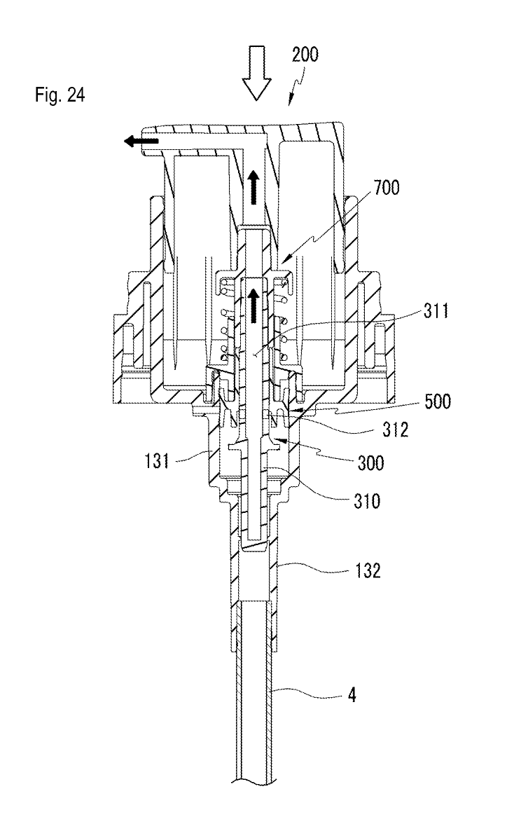

FIG. 23 is a cross-sectional view illustrating a state where the content within the container body flow into the discharge pump, and FIG. 24 is a cross-sectional view illustrating a state where the content introduced into the discharge pump is discharged to the outside.

As shown in FIG. 23, when the valve 300 ascends, the first inflow hole formed in the tube fixing tube 132 is opened to introduce the content within the container body 2 into a space of the content inflow tube 131 through the pumping tube 4 and the tube fixing tube 132 by a pressure difference. That is, since the content within the content inflow tube 131 are discharged to the outside when the valve stem 310 descends, the inside of the content inflow tube 131 becomes to a state approaching a vacuum state. Thus, the content within the container body 2 are smoothly introduced into the content inflow tube 131.

Here, since the second inflow hole 312 defined in the valve stem 310 is blocked by the valve holder 500, the content within the content inflow tube 131 may not be introduced into the valve stem 310.

As shown in FIG. 24, when the user pushes the push button 200 to allow the valve stem 310 to descend, the lower end of the valve stem 310 may block the first inflow hole of the tube fixing tube 132 to prevent the content within the container body from being introduced into the content inflow tube 131. Simultaneously, the second inflow hole 312 defined in the valve stem 310 may be opened to introduce the content within the content inflow tube 131 into the vertical transfer path 311 of the valve stem 310 through the second inflow hole 312, and then to discharge the content through the connection tool 700 and the push button 200.

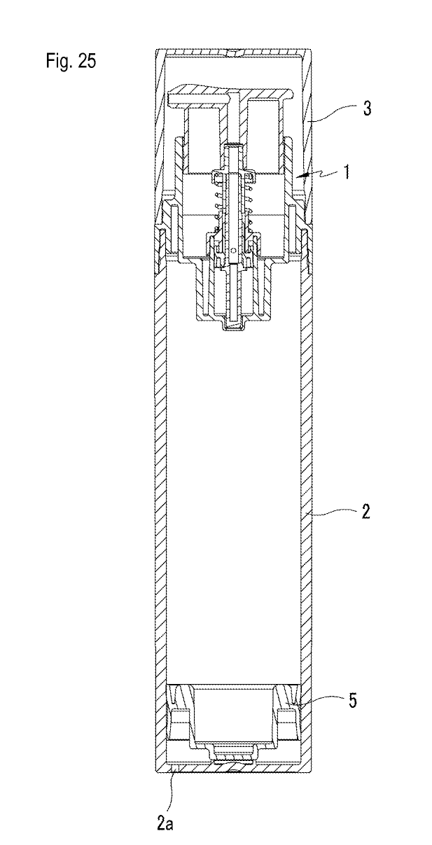

FIG. 25 is a cross-sectional view of a cosmetic container to which a discharge pump is applied according to a second embodiment of the present invention.

A pressing holder 5 for smoothly discharging content is slidably inserted into container body 2. The pressing holder 5 may press the liquid content and push to an opened portion of the container body 2. The liquid content is filled between a discharge pump 1 and the pressing holder 5 from the inside of the container body 2.

An air inflow hole 2a through which air is introduced between the pressing holder 5 and a closed bottom surface of the container body 2 is defined in a bottom surface of the container body 2.

The pressing holder 5 may ascend to push the liquid content up due to a pressure difference between a portion filled with the liquid content and a portion filled with the air with respect to the pressing holder 5. That is, when the liquid content is discharged, a space generated by discharging the liquid content may become to a vacuum state, and thus a pressure in an upper side of the pressing holder 5 may be lowered than that in a lower side of the pressing holder 5. Therefore, the pressing holder 5 may smoothly ascend to prevent an empty space from being generated in the upper side of the pressing holder 5.

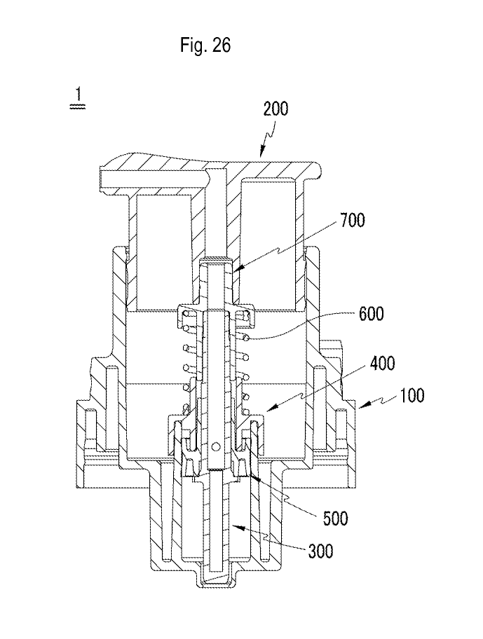

FIG. 26 is a cross-sectional view of the discharge pump of FIG. 25, and FIG. 27 is a cross-sectional view of a pump body.

The discharge pump 1 according to the current embodiment includes a pump body 100, a push button 200, a valve 300, an end cap 400, a valve holder 500, a spring 600, and a connection tool 700. Here, the components except the pump body 100 are the same as those described in the first embodiment, and thus the redundant description will be omitted.

The pump body 100 includes a container coupling unit 110, a valve mounting unit 120, and a content inflow unit 130A, which are integrally injection-molded. Here, the components except the content inflow unit 130A are the same as those described in the first embodiment, and thus the redundant description will be omitted. Like the reference numerals refer to identical components having an identical function as described in the first embodiment.

The content inflow unit 130A provides a space in which the content of the container body 2 is introduced when the valve 300 is elevated. The content inflow unit 130A includes an inflow tube support holder 131A extending from a lower end of the valve mounting unit 120 and having a closed lower end to support a content inflow tube (that will be described below) therein and a cylindrical content inflow tube 132A vertically disposed from an inner bottom of the inflow tube support holder 131A. An inflow port 133A having an inflow hole 133a connected to the content inflow tube 132A to introduce the content of the container body 2 into the content inflow tube 132A protrudes downward from a bottom surface of the inflow tube support holder 131A. Each of the inflow tube support holder 131A and the content inflow tube 132A may have an opened upper end.

The discharge pump making sounds when pumping according to the present invention may have following effects.

Firstly, since the portion of the spring is bent to form the sound making unit, the sound making unit may make sounds through the simple structure when pumping to easily adjust the number of pumping and also reduce manufacturing and replacing costs due to the whole simple structure thereof.

Secondly, the content within the container body may be easily discharged to the outside by being pushed only by the user's hand. Also, the inflow of the content may be adjusted by using only the valve without using components corresponding to an opening/closing member according to the related art. Also, since the portion (corresponding to a housing in the related art) to which the valve is accommodated is integrated with the portion (corresponding to a closer in the related art) coupled to the container body, the pumping structure may be simplified when compared to that in the related art. Therefore, the discharge pump according to the present invention may be easily assembled and manufactured to reduce the manufacturing costs.

As described above, although the discharge pump of the present invention is described with reference to the exemplary embodiments, the present invention is not limited to specific embodiments. The invention may be freely modified by a person skilled in the art within the scope of the claims hereinafter.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A discharge pump making sounds when pumping, characterized in that when a push button is pushed, a content within a container is pumped and discharged to the outside, and when force pushing the push button is released, the push button returns to its original state by a coil spring,
wherein a sound making unit for making sounds, which contacts and overlaps all or a portion of a plurality of spiral parts constituting the coil spring when compressed, and returns to its original state while scratching the spiral parts contacting the sound making unit when tensioned, thereby making the sounds, is bent from the spiral unit disposed on an end of the coil spring.

2. The discharge pump of claim 1, wherein the sound making unit comprises a first bending part bent from the spiral part to overlap the spiral parts when compressed; and
a second bending part bent from an end of the first bending part to scratch the spiral parts when tensioned, thereby making the sounds.

3. The discharge pump of claim 2, wherein the first bending part is inclinedly bent toward a central portion of the spiral parts so that the first bending part contacts the spiral parts when the spiral parts are compressed and tensioned, the second bending part is inclinedly bent in the inclined direction of the spiral part.
